(19) United States
(12) Patent Application Publication
(10) Pub. No.: US 2025/0217219 A1
(43) Pub. Date: Jul. 3, 2025

(54) TRANSACTIONAL TIMEOUTS FOR MANAGING CRITICAL DOMAINS

(71) Applicant: ADVANCED MICRO DEVICES, INC., Santa Clara, CA (US)

(72) Inventors: Balatripura S. Chavali, Austin, TX (US); Kaushal Amolak Sanghai, Boxborough, MA (US); Uma Sankara Rao Balla, Hyderabad (IN); Carl Kittredge Wakeland, Santa Clara (CA)

(21) Appl. No.: 18/398,411

(22) Filed: Dec. 28, 2023

(51) Int. Cl. G06F 11/07

(52) U.S. Cl. CPC G06F 11/0757; G06F 11/0721; G06F 11/0793; G06F 2201/835

(57) ABSTRACT

Processing systems and associated methods are provided for managing tasks and handling errors based on criticality levels assigned to individual processing circuitry blocks. The system includes a plurality of processing circuitry blocks, each assigned a level of criticality by a critical domain manager, such that errors arising in relation to these blocks are handled in accordance with their assigned level of criticality. The system features timers assigned to tasks initiated by the processing circuitry blocks, with timeout durations determined by the criticality levels respectively assigned to the processing circuitry blocks and tasks initiated by them. Upon timeout expiration without task completion, various error handling procedures are selected and executed based on the assigned criticality levels.

### BACKGROUND

Automobile sound systems typically include a system-on-chip (SOC) that centralizes audio processing functions for various in-vehicle applications. These SOCs are designed to handle a wide range of audio-related tasks, from basic media playback to more complex operations such as voice recognition, hands-free calling, and emergency communication systems.

Traditionally, SOCs in automobile sound systems have been designed to treat all audio processing tasks with equal priority for safety-critical and non-safety-critical tasks. This conventional design lacks the flexibility to differentiate between tasks of varying criticality. For example, playing music or streaming media is generally considered less critical than making emergency calls or alerting drivers to external hazards. The inability to prioritize tasks based on their criticality can lead to inefficient resource allocation and potential delays in executing high-priority tasks.

The current landscape of automotive audio processing thus presents a need for a more sophisticated approach that can dynamically manage tasks based on their criticality. Such an approach would ensure that high-priority tasks are given the necessary resources and attention, while lower-priority tasks are managed in a way that does not compromise the system's overall efficiency and reliability.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system for handling task errors based on assigned levels of criticality in accordance with some embodiments.

FIG. 2 partially illustrates a component view of an automobile audio processing system in accordance with some embodiments.

FIG. 3 illustrates a partial component view of an audio co-processor (ACP) in accordance with some embodiments.

FIG. 4 illustrates the composition and functionalities of a critical domain and error manager as configured in accordance with some embodiments.

FIG. 5 illustrates an error handling procedure in accordance with some embodiments and scenarios.

FIG. 6 illustrates another error handling procedure in accordance with some embodiments and scenarios.

### DETAILED DESCRIPTION

As noted above, conventional SOCs in automobile sound systems have been designed to treat all audio processing tasks with equal priority for safety-critical and non-safety-critical tasks. As part of that approach, such systems generally utilize generic timeout mechanisms to manage task execution times, and again fail to account for the varying nature and criticality of different audio tasks. A uniform timeout approach may lead to premature termination of critical tasks or unnecessary continuation of non-critical ones, affecting the overall performance and reliability of the audio processing system.

Embodiments described herein provide an improved audio processing system in automotive and other applications, capable of dynamically managing multiple tasks with varying levels of criticality. In certain embodiments, the audio processing system assigns different criticality levels to various task initiators and/or to tasks from such initiators, assigning a bespoke timeout value (a threshold duration limiting the expected execution time) for each task based on its criticality and providing both soft- and hard-reset options to handle task timeouts effectively. In various embodiments, the audio processing system may be implemented as an audio co-processor (ACP), such as may handle audio processing and related tasks in a system that comprises one or more central processing units (CPUs), graphical processing units (GPUs), or other hardware processors.

In various embodiments, an audio processing system operating in accordance with techniques described herein utilizes software-controlled assignment of individual digital signal processors (DSPs) or other functional circuitry blocks of the audio processing system to the critical domain (treating initiators assigned to that domain as having a heightened level of criticality relative to those not in the critical domain), as opposed to previous approaches in which the scope of the critical domain was fixed in hardware. In such embodiments, individual DSPs and other task initiators can be dynamically assigned as critical or non-critical based on the software configuration, which can be adjusted according to the specific requirements of different scenarios or applications. For example, in an automotive context, a telephony circuitry block responsible for emergency phone calls (e.g., 9-1-1 calls) may always be assigned to the critical domain, while media playback DSPs may only be assigned a heightened level of criticality if the incorporating vehicle has been motionless for some period of time. As another example, in some embodiments and scenarios, one or more alerts and chimes may be designated safety-critical and thereby be assigned a heightened level of criticality. By using software to define critical and non-critical domains, the ACP architecture can respond to changing operational needs, providing a more resilient and adaptable system compared to those with fixed hardware-defined criticality domains.

Although examples discussed herein are described in the specific context of automotive audio processing, it will be appreciated that embodiments of techniques described herein are not limited to that specific context. As additional non-limiting examples, aspects of such techniques may be utilized in home entertainment systems, in which prioritizing audio tasks such as voice commands over background music can enhance user experience; in industrial, aerospace, and maritime applications, such as to manage audio alerts in noisy environments and to improve the reliability and effectiveness of audio processing; and other environments and scenarios. In addition, such techniques may be utilized in non-audio-processing applications, such as in any endeavor in which flexible allocation of criticality between subsystems is useful.

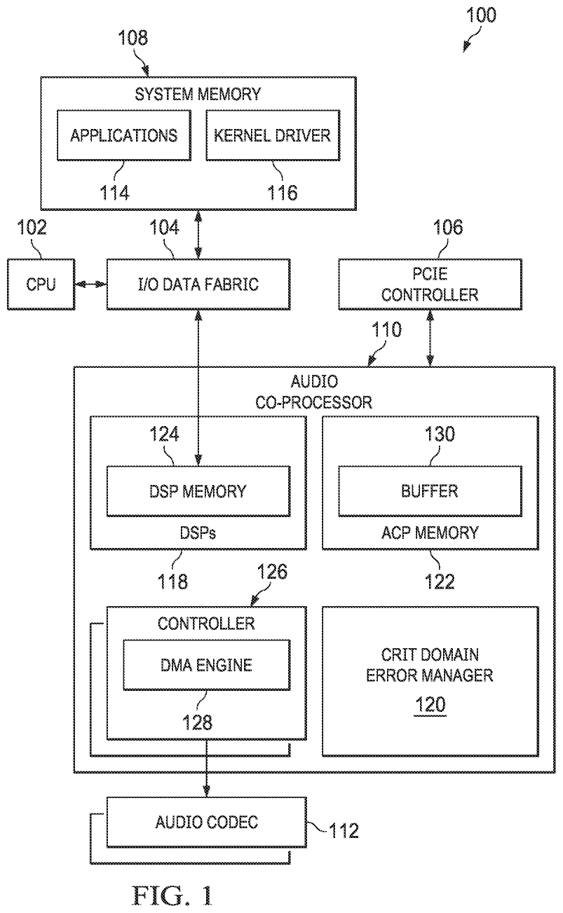

FIG. 1 is a block diagram of a processing system 100 including an advanced task management system to manage and prioritize tasks based on their criticality and initiator-specific parameters, in accordance with some embodiments. In the example shown in FIG. 1, the processing system 100 is a system-on-chip (SoC) device capable of implementing one or more techniques described herein. The SoC device, in at least some implementations, comprises multiple functional circuitry blocks (also referenced herein as circuitry blocks or simply blocks) is a component of the computing system 100 illustrated in FIG. 1 or is separate from the computing system 100. The processing system 100 is implemented as a SoC for the sake of example. However, in other implementations, any suitable computing device, such as a personal computer, server, smart phone, tablet computer, and so forth, are used. Such devices are implemented using either SoCs, discrete system components, or both in some implementations. It should be understood that FIG. 1 omits depiction of various components of the processing system 100 for clarity and ease of description. According to some embodiments, the processing system 100 is configured for one or more applications in an automobile, such as an automotive infotainment system. As an example, in some embodiments, the processing system 100 includes an audio co-processor for automobile applications.

In at least some implementations, the processing system 100 includes components such as a central processing unit (CPU) 102, an input/output (I/O) data fabric 104, a peripheral component interconnect enhanced (PCIe) controller 106, system memory 108, an audio co-processor (ACP) 110, audio codec 112, and the like. One or more of these and other components, in at least some implementations, are comprised of intellectual property (IP) blocks/cores, which are reusable units of logic, cells, or integrated circuit (IC) layouts.

The CPU 102, in at least some embodiments, is a CPU core complex that includes one or more suitable CPU cores. Each of the cores in a complex, in at least some implementations, includes a private cache and all of the cores in a complex are in communication with a shared cache. In at least some implementations, the processing system 100 includes a plurality of CPU core complexes. In at least some implementations, the CPU 102 is a parallel processor, such as any suitable parallel processor (e.g., graphics processing unit (GPU), machine learning (ML) application-specific integrated circuit (ASIC), etc.) or a combination of parallel processors. In other implementations, the processing system 100 includes one or more parallel processors (not shown) in addition to the CPU 102.

The data fabric 104, in at least one implementation, includes circuitry for providing communication interconnections among the various components of the processing system 100. Any suitable interconnection hardware is used in various implementations. In some implementations, from a physical standpoint, the data fabric 104 is implemented either in a central location of the processing system 100 or distributed to multiple hubs across the processing system 100 and interconnected using a suitable communications medium (e.g., a bus). From a logical standpoint, the data fabric 104 is located at the center of data flow, and information regarding the idleness of different components (including IP blocks) of the processing system 100 is concentrated (e.g., stored) in the data fabric 104.

The PCIe controller 106 is an example one type of I/O controller implemented by the processing system 100. The PCIe controller 106 includes circuitry for managing a PCIe interface between I/O devices and the I/O data fabric 104. Examples of other I/O controllers include a universal serial bus (USB), a non-volatile memory host controller interface (NVMe) bus, a serial advanced technology attachment (SATA) bus, a gigabit Ethernet (xGBE), a secure digital (SD) interface, a general-purpose input/output (GPIO) connection, a sensor fusion I/O connection, and or any other suitable I/O hardware.

A memory controller (not shown) manages access to system memory 108. For example, requests from the CPU 102 or other devices for reading from or for writing to system memory 108 are managed by the memory controller. In some embodiments, one or more applications 114 within the system memory 108 include various programs or commands to perform computations that are also executed at the CPU 102. The system memory 108, in at least some implementations, also includes an operating system (not shown) and kernel mode driver 116. The kernel mode driver 116 controls operation of the audio co-processor (ACP) 110 by, for example, providing an application programming interface (API) to software (e.g., applications 114) executing on the ACP 110 to access various functionality of the ACP 110. The kernel mode driver 116, in at least some embodiments, also includes a just-in-time compiler that compiles programs for execution by processing components of the ACP 110.

In at least some implementations, the system memory 108 includes non-persistent memory, such as dynamic random-access memory (not shown). In various embodiments, the system memory 108 stores processing logic instructions, constant values, variable values during execution of portions of applications or other processing logic, or other desired information. For example, in various embodiments, parts of control logic to perform one or more operations on CPU 102 reside within system memory 108 during execution of the respective portions of the operation by CPU 102. During execution, respective applications, operating system functions, processing logic commands, and system software reside in system memory 108. Control logic commands that are fundamental to operating system generally reside in system memory 108 during execution. In some embodiments, other software commands (e.g., a set of instructions or commands used to implement a device driver) also reside in system memory 108 during execution of the processing system 100.

The audio co-processor 110, in at least some implementations, is a dedicated co-processor device configured to perform calculations on audio data. In at least some implementations, the audio co-processor 110 includes one or more digital signal processors (DSPs) 118, a plurality of controllers 126 such as Integrated Inter-chip Sound (I2S) controllers or Time Division Multiplexing (TDM) controllers, and memory 122 (e.g., dynamic random-access memory (DRAM) or any other suitable type or memory). I2S is a digital audio serial bus interface transmission standard used for connecting digital audio devices together. For example, I2S is used to communicate digital audio data, such as pulse-code modulation (PCM) audio data, between internal devices of an electronic device such as a codec, a digital signal processor (DSP), a digital-to-analog converter (DAC), an analog-to-digital convertor (ADC), a digital input/output interface, a digital filter, and the like. Time Division Multiplexing (TDM) is an interface that allows multiple channel audio data transfers over a single data line, thus increasing the amount of data that can be transmitted via a single line.

It will be appreciated that additional components of the audio co-processor 110 have been omitted for clarity and ease of illustration. Also, in at least some implementations, functionality of the ACP memory 122 is partially incorporated or replaced by one or more of the system memory 108, or the DSP memory 124. The ACP memory 122, in certain implementations, includes one or more buffers 130 for the controllers 126. In other implementations, the one or more buffers 130 are included in the respective controllers 126 such that, e.g., each controller 126 includes a buffer 130.

In the depicted embodiment, the DSPs 118 include memory 124 (e.g., static random-access memory or SRAM), and a multiplexer (not shown). In certain implementations, the multiplexer is implemented as a software audio component/plugin initiated by one of the DSPs 118. As described in greater detail elsewhere herein, in various embodiments, the DSPs 118 may include multiple DSPs that are each associated with a corresponding DSP memory or memory range. The DSPs 118 are configured to carry out digital signal processing algorithms (e.g., for audio processing). Examples of such algorithms include finite impulse response (FIR) filtering algorithms, etc. Typically, a DSP performs such algorithms more efficiently (e.g., faster and/or using less power) than a CPU or other processor in a computing system. Accordingly, in some implementations, a host OS (not shown) implemented on the processing system 100 transfers data to the DSPs 118 to perform such calculations, and retrieves or receives the results after the DSPs 118 have completed the calculations. In certain embodiments, each of the DSPs 118 includes firmware running on the audio co-processor 110 and one or more ring buffers (i.e., circular buffers), which are implemented in the DSP memory 124 in this example or are implemented in other hardware in other implementations.

In the depicted embodiment, each of the I2S controllers 126 includes a direct memory access (DMA) controller/engine 128. It should be understood that additional components of the I2S controllers 126 have been omitted for clarity and ease of description. In some embodiments, each I2S controller 126 uses its DMA engine 128 to fetch audio data from any of a number of audio data sources in the processing system. For example, in some embodiments, the DMA engines 128 fetch audio data from the ACP memory 122, from the DSP memory 124, or from system memory 108 based on commands issued by the respective I2S controllers 126. Each I2S controller 126 includes a buffer (not shown) that is filled by the DMA engine 128 associated with the I2S controller 126.

The critical domain error manager (CDEM) 120 comprises circuitry and/or software configured to oversee error management and detect a variety of system anomalies, including uncorrectable or other ECC errors in memory components and timeout errors. The CDEM 120 monitors watchdog timers associated with DSPs and other initiators as well as the tasks initiated by those initiators. In certain embodiments, upon detecting an error, the CDEM 120 is configured to initiate a series of predefined response measures, tailored to the specific nature of the detected fault. In various embodiments, such measures include isolating affected components to prevent systemic impact, and executing soft- and hard-reset commands targeted at individual DSPs or the ACP 110. This level of granularity in response protocol allows for a nuanced approach to error handling, ensuring that system stability is promptly restored with minimal disruption to ongoing operations.

In certain embodiments, the CDEM 120 operates as a critical domain manager, such as to assign levels of criticality to each of a plurality of processing circuitry blocks (e.g., DSPs and other processing blocks) and assign timers to tasks initiated by those processing blocks; and/or error handling manager that is configured to monitor the processing blocks, and to handle errors based at least in part on those assigned levels of criticality. In other embodiments, critical domain management functions and error handling functions are managed separately, such as by distinct critical domain management circuitry and error handling circuitry, or by distinct sets of processor-executable instructions embodied in hardware, software, firmware, or some combination thereof.

In various embodiments, the CDEM 120 manages the delineation of critical and non-critical domains within the ACP 110, ensuring that components within the critical domain (those identified as having a heightened level of criticality relative to non-critical components) are insulated from failures occurring in the non-critical domain (those identified as not having a heightened level of criticality). In certain embodiments, the CDEM 120 additionally handles error logging.

In certain embodiments, the management of tasks and handling of errors is differentiated based on the criticality level assigned to each processing block and the tasks they initiate. For example, the CDEM 120 assigns varying levels of criticality to processing blocks and their respective tasks, such as assigning longer timeout durations to tasks from initiators within the critical domain, reflecting a higher tolerance for delays.

In some embodiments, the CDEM 120 may act in response to detecting one or more errors in tasks initiated by critical domain blocks in a manner designed to preserve continuous operation. For example, in various scenarios, the CDEM 120 may attempt multiple soft reset protocols or employ other measures intended to minimize disruption to these critical functions. For example, in certain embodiments the CDEM 120 may execute a soft reset protocol (potentially one of multiple such protocols that are attempted in turn prior to execution of one or more hard reset protocols) in which a task that has exceeded its assigned timeout value is instead erroneously reported by the CDEM 120 as having been successfully completed. In this manner, the CDEM 120 provides the processing circuitry block that initiated the timed-out task with an opportunity to continue uninterrupted operation, in accordance with its heightened level of criticality.

In contrast, tasks initiated by non-critical domain initiators may be subjected to more immediate and comprehensive reset protocols (generally termed hard resets). In scenarios in which soft resets fail, CDEM 120 may quickly escalate to initiating hard resets for non-critical initiators, prioritizing rapid error resolution over operational continuity. In general, as used herein a hard reset is one that includes initialization of some or all functions of the task initiator.

In certain embodiments, each initiator within the system is associated with one or more watchdog timers. The management of errors detected by these timers varies based on the criticality of the associated initiator. While critical initiators might continue to operate under certain error conditions, non-critical initiators could be subject to stalling or resetting, reflecting prioritization of critical operations.

In certain embodiments, this differentiated approach extends to error logging, with critical errors triggering more immediate and high-priority responses. In contrast, errors from non-critical tasks might be logged for subsequent analysis, indicative of their lower immediate impact on overall system operation.

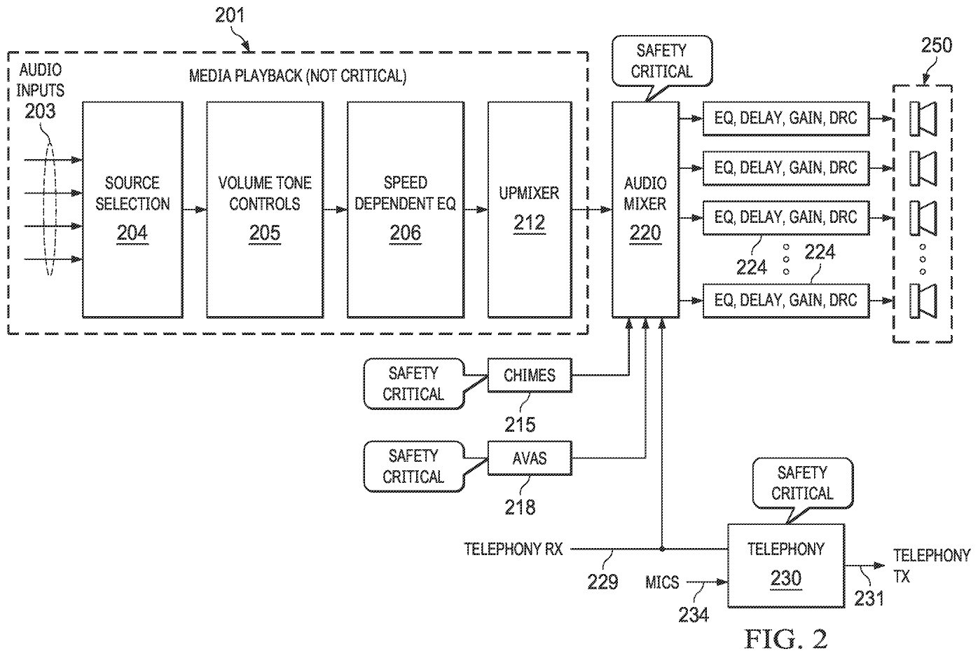

FIG. 2 partially illustrates a component view of an automobile audio processing system 200 in accordance with some embodiments. The system 200 includes a variety of components designed to handle diverse audio processing tasks, with certain blocks identified as safety critical.

The media playback block 201 functions as a primary input source, handling different types of audio inputs 203. In various embodiments, such audio inputs 203 include one or more connections from audio sources such as streaming audio sources, Bluetooth or other wired/wireless local sources, radio sources, multichannel audio sources, etc. The audio inputs 203 are first directed to source selection 204, then pass through volume tone controls 205, speed dependent equalizer 206, and eventually to an upmixer 212. The upmixer 212, which enhances audio in various manners (e.g., by generating three-dimensional audio based on one- or two-dimensional audio input data, outputs to audio mixer 220. As used herein, a speed dependent equalizer refers to an audio equalization system that adjusts its settings based on the speed of the vehicle, such as to optimize or otherwise improve audio quality and intelligibility at different vehicle speeds.

The chimes block 215 and Acoustic Vehicle Alerting System (AVAS) 218, both identified as “safety critical” components, provide essential auditory alerts and notifications: AVAS is a safety feature in electric and hybrid vehicles that generates artificial noise to alert pedestrians of the vehicle's presence, especially at low speeds; chimes block 215 produces auditory alerts or signals for various vehicle notifications, such as seatbelt warnings, door ajar alerts, or other important vehicle status updates. The spatial mixer 220, identified as safety critical, integrates audio inputs from various sources including the media playback block 201, chimes block 215, AVAS 218, and the telephony receiver 229. The telephony receiver 229 processes incoming telephony signals, routing them to the spatial mixer 220 and/or to the telephony block 230. The telephony block 230, another safety-critical component, handles telephony processing and sends outgoing signals through the telephony transmitter 231.

Microphone inputs 234 provide input to the telephony block 230 for call functionalities. The effects blocks 224 (labeled ‘EQ, Delay, Gain, DRC,’ to exemplify various functions potentially performed by those effects blocks) receive input from the spatial mixer 220 and provides output via audio outputs 250.

As used herein, an initiator refers to a component, block, or subsystem—within or external to the audio processing system 200—that requests or initiates a particular process or task. This could include initiating audio signal processing, generating control commands, or activating specific functions in response to various inputs or predefined conditions. Thus, in various embodiments, some or all of the depicted components of the audio processing system 200 may operate at various times as an initiator. Furthermore, while the illustration of FIG. 2 has been simplified for ease of illustration, it will be appreciated that in certain embodiments various of the depicted components of the audio processing system 200 (e.g., any or all of volume tone controls 205, speed dependent equalizers 206, upmixer 212; audio mixer 220; effects blocks 224; and telephony block 230) include one or more digital signal processors (DSPs), each of which can operate at various times as an initiator.

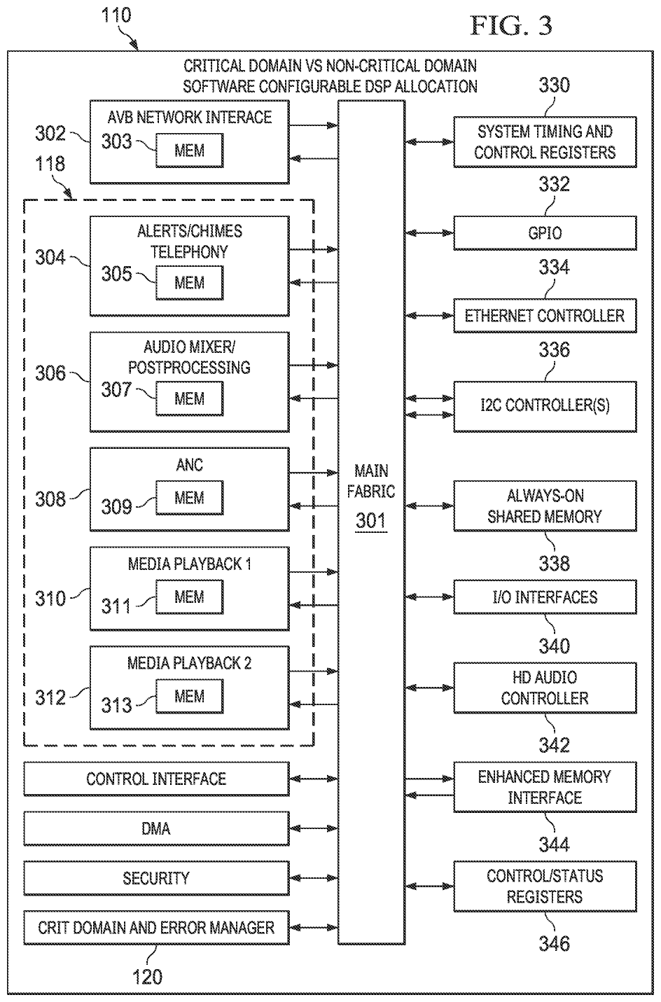

The architecture of the automobile audio processing system 200 prioritizes critical audio tasks in automotive environments, prioritizing the execution of audio functions with heightened levels of criticality such as emergency alerts and communications. Moreover, although in the embodiment of FIG. 2 each of the chimes block 215, AVAS 218, telephony block 230 and spatial mixer 220 are indicated as having a same heightened level of criticality (“safety critical”), in various embodiments multiple levels of heightened criticality are supported by the automotive audio processing system 200, as well as by embodiments of the audio processing system 100 of FIG. 1 and audio co-processor (ACP) 110 of FIGS. 1 and 3, as described in greater detail elsewhere herein.

FIG. 3 illustrates a partial component view of the audio co-processor (ACP) 110 in accordance with some embodiments. A main fabric 301 serves as a logical connection fabric and central hub, interlinking various components of the ACP 110 in a manner similar to that described with respect to data fabric 104 of FIG. 1, and comprises circuitry for providing interconnections among the various components of the ACP 110.

In the depicted embodiment, the main fabric 301 is connected to an Audio Video Bridging (AVB) Network Interface 302 and corresponding dedicated memory 303, facilitating network communication and data processing. As used herein, ethernet AVB refers to a collection of technical standards that enhance the capabilities of Ethernet networks for improved synchronization, low-latency, and reliability of data transmission. The AVB standards generally support timing and synchronization for time-sensitive applications, also known as generalized Precision Time Protocol (gPTP); forwarding and queuing for time-sensitive streams (FQTSS); quality of service standards; transport of real-time content; and bandwidth reservation.

The ACP 110 includes multiple DSPs, collectively referred to herein as DSPs 118, which in the depicted embodiment includes an alerts/chimes/telephony DSP 304 with memory 305, an audio mixer/postprocessing DSP 306 with memory 307, an Active Noise Cancellation (ANC) DSP 308 with memory 309, and media playback DSPs 310, 312, which are respectively coupled to corresponding memories 311, 313. In various embodiments, each of the DSPs 118 may comprise disparate, similar, or identical hardware architecture with respect to one another; similar or identical hardware architectures may provide different respective functionalities via software or firmware implementation.

The critical domain error manager 120 is also connected to the main fabric 301, overseeing error management within the ACP 110. The control interface 316 facilitates interactions and command processing within the system. For data transfer, the Direct Memory Access (DMA) 318 is integrated, enabling efficient movement of data within the system. The security component 320 ensures the integrity and protection of data and system operations.

System timing & control registers 330 are incorporated to manage system timing, resets, and power gating functionalities. The GPIO 332 enables versatile input/output interactions. An ethernet controller 334 supports network communications, while the I2C controller(s) 336 handle serial communication tasks. An always-on shared memory 338, featuring error correction and access control, provides persistent and reliable storage. I/O interfaces 340 accommodate various audio and data interfaces, including Time Division Multiplexing (TDM) and others. The High-Definition (HD) audio controller 342 manages high-quality audio processing. An enhanced memory interface 344 supports robust memory interactions, and control/status registers 346 are included for system monitoring and control functions. It will be appreciated that the particular configuration depicted for ACP 110 is merely exemplary, and that in various embodiments and scenarios, any variety of interfaces, memories and memory controllers, and other components may be utilized in accordance with techniques described herein.

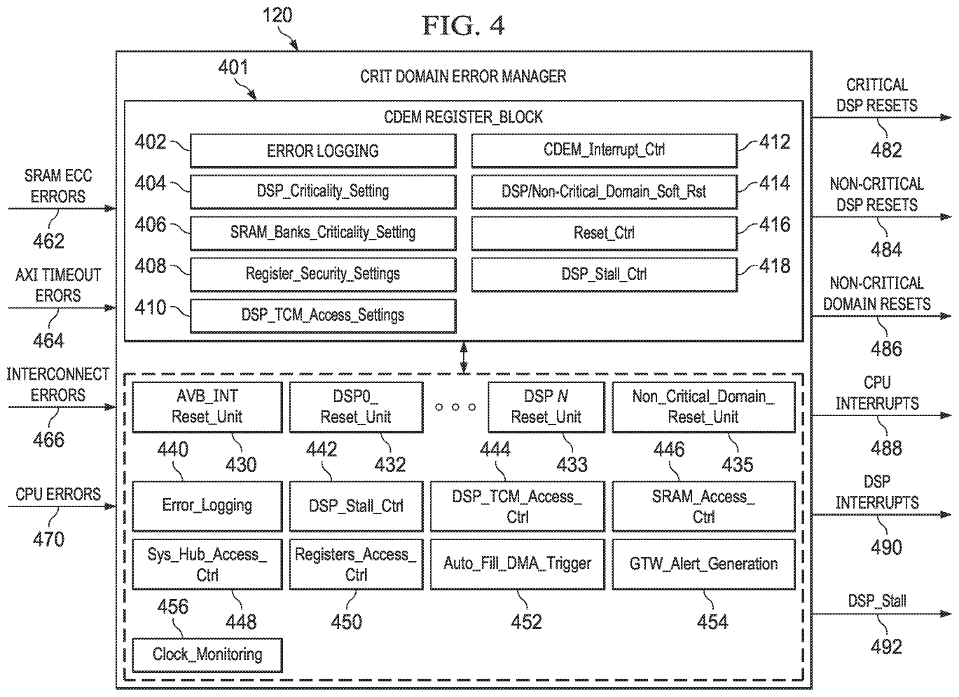

FIG. 4 illustrates the composition and functionalities of the CDEM 120 as configured in some embodiments. The CDEM 120 encompasses a range of registers and functional blocks that collectively contribute to its comprehensive error management capabilities within the ACP.

In the depicted embodiment, a CDEM register block 401 comprises various settings and registers utilized for operation of the CDEM 120 and the ACP 110. An error logging register 402 maintains records of system anomalies, such as for diagnostic purposes. DSP criticality settings 404 allow for individual DSPs to be marked as critical or non-critical. In certain embodiments, DSPs identified as critical do not access system memory, while DSPs identified as non-critical are allowed to access system memory. Memory criticality settings 406 enable configuration of memory components based on their importance in system operations. Register security settings 408 provide an added layer of security, controlling access to the CDEM's registers. DSP TCM access settings 410 manage access to the tightly coupled memories of DSPs, ensuring controlled memory sharing aligned with system criticality. CDEM interrupt control 412 regulates the CDEM's response to system interrupts. DSP non-critical domain reset settings 414 govern the reset protocols for DSPs in the non-critical domain. Reset control 416 manages the CDEM's overall reset functionality. A DSP stall control 418 enables a stall of specific DSPs as a response to certain error conditions.

In addition to the register block, the CDEM 120 includes a range of functional blocks 420. These blocks store data and instructions pertaining to various error management functions. Notable among these are the AVB interface reset unit 430, which oversees resets related to the AVB interface, and DSP 0-N reset units 432, 433, representing reset units that individually correspond to any quantity of DSPs in the ACP 110. The non-critical domain reset 435 addresses reset signals within the non-critical domain of the ACP. Error logging 440 complements the error logging registers 402 by providing logging capabilities. DSP stall control 442, DSP TCM access control 444, memory access control 446, system hub access control 448, registers access control 450, auto-fill DMA trigger 452, gateway alert generation 454, and clock monitoring 456 are additional functional blocks, each contributing to specific aspects of error management within the CDEM 120.

The CDEM 120 also receives a variety of input signals, indicative of various system states and error conditions. These include memory ECC error signals 462, bus (e.g., Advanced extensible Interface or AXI) timeout error signals 464, interconnect error signals 466, and CPU error signals 470. These inputs allow the CDEM 120 to respond dynamically to different error scenarios within the ACP 110.

Moreover, the CDEM 120 outputs a range of signals based on its internal processes and error assessments. These outputs include critical DSP reset signals 482, non-critical DSP reset signals 484, non-critical domain reset signals 486, CPU interrupts 488, DSP interrupts 490, and DSP stall signals 492. Each output signal serves a specific purpose in managing the CDEM's response to system errors.

The CDEM 120 provides flexible and robust error handling. In various embodiments and scenarios, each of the functional blocks 420 may be utilized independently or in one or more combinations with one or more other of those functional blocks. As non-limiting samples, the CDEM 120 may utilize one or more of the functional blocks 420 to provide watchdog timers for monitoring and error detection of each DSP and/or other initiator; support hardware-driven CPU and system memory error handling, including the detection and logging of both soft and hard error conditions and the automatic stalling of DSPs upon encountering configured error conditions (e.g., the expiration of an assigned timeout); and provide watchdog and NIC hang monitoring, as well as interconnect parity or bus fail detection.

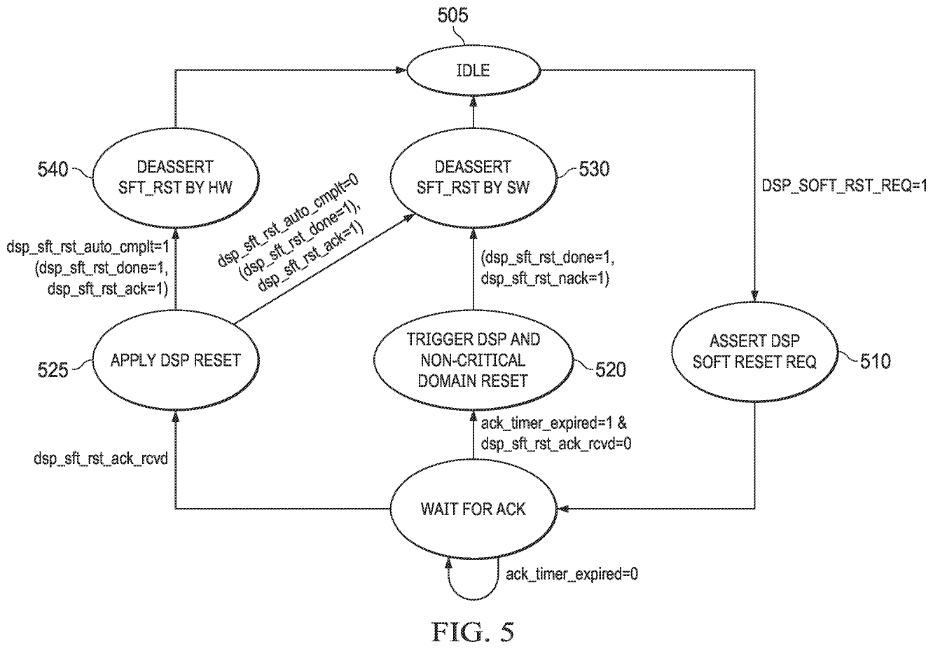

FIG. 5 illustrates an operational flow for a reset process 500 initiated for a DSP or other initiator in the non-critical domain, such as in response to a timeout value being exceeded for a task initiated by that DSP or other initiator. In the depicted embodiment, the reset process 500 is performed by a critical domain error manager (e.g., CDEM 120 of FIGS. 1, 3, and 4) on a DSP without any heightened level of criticality (e.g., media playback DSP 310 of FIG. 3).

The process begins in an IDLE state (505), in which the CDEM awaits a condition that necessitates a soft reset. Upon detecting such a condition, the CDEM progresses to ASSERT DSP SOFT RESET REQ (510), in which the CDEM asserts a soft reset request targeted at the specific DSP.

Following the assertion, the reset process 500 moves to WAIT FOR ACK (515), in which the CDEM waits for an acknowledgment signal from the DSP. If the acknowledgment is not received within a specified time (ack_timer_expired), the process escalates to TRIGGER DSP AND NON-CRITICAL DOMAIN RESET (520), in which the CDEM asserts a more comprehensive reset process for the specific non-critical DSP.

In contrast, if an acknowledgment is received (dsp_sft_rst_ack_rcvd) prior to the expiration of the assigned timeout value, the process proceeds to APPLY DSP RESET (525), in which the reset is initiated for the DSP. Depending on the configuration (dsp_sft_rst_auto_cmplt), the reset process might be completed automatically by hardware (540—DEASSERT SFT_RST BY HW), or it may require software intervention to complete the reset (530—DEASSERT SFT_RST BY SW). In either case, once the reset is complete, the process returns to the IDLE state (505).

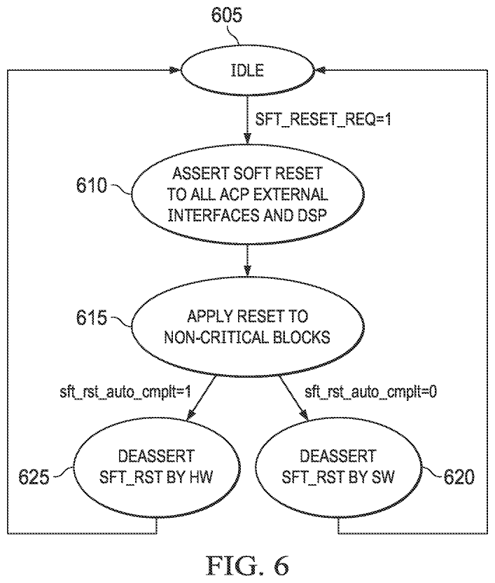

FIG. 6 illustrates an operational flow for a reset process 600, such as may be performed by a critical domain error manager in accordance with some embodiments. The reset process 600 is generally applicable for scenarios in which a soft reset is required for all external interfaces and initiators within the ACP 110. The reset process in FIG. 6 represents a comprehensive system-wide reset, and generally addresses a broader scenario than that of the reset process 500 for individual DSPs or initiators within the non-critical domain.

The reset process 600 begins in the IDLE state (605), in which the CDEM 120 is in a monitoring mode, awaiting conditions that necessitate a system-wide soft reset. Upon detecting such a condition, indicated by SFT_RESET_REQ=1, the CDEM 120 asserts a soft reset signal across all external interfaces and initiators (“ASSERT SOFT RESET TO ALL ACP EXTERNAL INTERFACES AND DSP”) at block 610.

At block 615, CDEM 120 applies the reset to non-critical initiators of the ACP, avoiding undue impact to critical operations. Depending on the reset process's completion status (as indicated by sft_rst_auto_cmplt) the flow can take two paths. If the reset is not automatically completed (sft_rst_auto_cmplt=0), the CDEM 120 proceeds to DEASSERT SFT_RST BY SW (620), where a software intervention is required to manually deassert the soft reset signal, concluding the reset process. Alternatively, if the reset process completes automatically (sft_rst_auto_cmplt=1), the reset process 600 proceeds to DEASSERT SFT_RST BY HW (625).

In both scenarios, following the deassertion of the soft reset signal, the process returns to the IDLE state (605).

In some embodiments, the apparatus and techniques described above are implemented in a system including one or more integrated circuit (IC) devices (also referred to as integrated circuit packages or microchips), such as the audio processing system(s) described above with reference to FIGS. 1-7. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

One or more of the elements described above (e.g., CDEM 120 and/or ACP 110, as non-limiting examples) is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing system, comprising:
a plurality of processing circuitry blocks;
critical domain management circuitry to assign a level of criticality to each of the processing circuitry blocks; and
error handling circuitry to monitor the processing circuitry blocks and to handle errors based at least in part on the assigned levels of criticality.

2. The processing system of claim 1, wherein the critical domain management circuitry assigns task timers to tasks initiated by the processing circuitry blocks, and wherein each task timer has a timeout duration that is based at least in part on the assigned level of criticality associated with the processing circuitry block that initiated the task.

3. The processing system of claim 1, wherein the critical domain management circuitry assigns task timers to tasks initiated by the processing circuitry blocks, and wherein each task timer has a timeout duration that is based at least in part on the assigned level of criticality associated with a processing circuitry block that is assigned to execute the task.

4. The processing system of claim 1, wherein to handle errors comprises initiating a soft reset protocol for a task based on a timeout associated with the task expiring prior to completion of the task.

5. The processing system of claim 4, wherein the soft reset protocol comprises providing a false indication to an initiating processing circuitry block that initiated the task associated with the timeout that the task has successfully completed.

6. The processing system of claim 4 wherein, responsive to a failure of the soft reset protocol to rectify an error condition, the error handling circuitry is configured to initiate a hard reset protocol for the processing circuitry block.

7. The processing system of claim 6, wherein the hard reset protocol comprises initializing the initiating processing circuitry block.

8. The processing system of claim 4, wherein the task associated with the timeout is initiated by a processing circuitry block assigned a heightened level of criticality, and wherein to handle the errors comprises initiating the soft reset protocol based at least in part on the heightened level of criticality assigned to the processing circuitry block.

9. The processing system of claim 1, wherein the critical domain management circuitry is further to:
assign a first task timer timeout value to a task initiated by a first processing circuitry block, the first processing circuitry block assigned a first level of criticality; and
assign a second task timer timeout value to a second task initiated by a second processing circuitry block, the second processing circuitry block assigned a second level of criticality that is higher than the first level of criticality;
wherein the second task timer timeout value is greater than the first task timer timeout value.

10. The processing system of claim 1, wherein the critical domain management circuitry is further to dynamically modify a level of criticality assigned to at least one processing circuitry block based on one or more changes to an operational state of the processing system.

11. The processing system of claim 1, wherein the plurality of processing circuitry blocks includes multiple digital signal processors (DSPs), and wherein at least one DSP of the multiple DSPs is assigned a higher level of criticality than one or more other of the multiple DSPs.

12. A method for managing a processing system, the method comprising:
assigning a level of criticality to each processing circuitry block of a plurality of processing circuitry blocks;
monitoring execution of tasks initiated by the processing circuitry blocks; and
responsive to errors associated with the execution of the initiated tasks, executing one or more error handling procedures based at least in part on the assigned levels of criticality.

13. The method of claim 12, further comprising assigning task timers to tasks initiated by the processing circuitry blocks, each task timer having a timeout duration that is based at least in part on the assigned level of criticality associated with the processing circuitry block that initiated the task.

14. The method of claim 12, further comprising assigning task timers to tasks initiated by the processing circuitry blocks, each task timer having a timeout duration that is based at least in part on the assigned level of criticality associated with a processing circuitry block that is assigned to execute the task.

15. The method of claim 12, wherein executing the one or more error handling procedures comprises initiating, responsive to expiration of a timeout associated with a task prior to task completion, a soft reset protocol for the task associated with the timeout.

16. The method of claim 15, wherein the soft reset protocol comprises providing a false indication to an initiating processing circuitry block that initiated the task associated with the timeout that the task has successfully completed.

17. The method of claim 15 further comprising, responsive to a failure of the soft reset protocol to rectify an error condition, initiating a hard reset protocol for the processing circuitry block.

18. The method of claim 17, wherein the hard reset protocol comprises initializing the initiating processing circuitry block.

19. The method of claim 15, wherein the task associated with the timeout is initiated by a processing circuitry block assigned a heightened level of criticality, and wherein executing the one or more error handling procedures comprises initiating the soft reset protocol based at least in part on the heightened level of criticality assigned to the initiating processing circuitry block.

20. The method of claim 12, further comprising:
assigning a first task timer timeout value to a task initiated by a first processing circuitry block, the first processing circuitry block being assigned a first level of criticality; and
assigning a second task timer timeout value to a second task initiated by a second processing circuitry block, the second processing circuitry block being assigned a second level of criticality that is higher than the first level of criticality;
wherein the second task timer timeout value is greater than the first task timer timeout value.

21. The method of claim 12, further comprising dynamically modifying a level of criticality assigned to at least one processing circuitry block based on one or more changes to an operational state of the processing system.

22. The method of claim 12, wherein the plurality of processing circuitry blocks includes multiple digital signal processors (DSPs), and wherein assigning a level of criticality to each processing circuitry block comprises assigning at least one DSP of the multiple DSPs a higher level of criticality than one or more other of the multiple DSPs.

23. A non-transitory computer-readable medium storing instructions that, when executed by one or more processors, cause the one or more processors to:
assign a level of criticality to each processing circuitry block of a plurality of processing circuitry blocks;
monitor execution of tasks initiated by the processing circuitry blocks; and
responsive to errors associated with the execution of the initiated tasks, execute one or more error handling procedures based at least in part on the assigned levels of criticality.
